(19) United States
(12) Patent Application Publication
(10) Pub. No.: US 2009/0324504 A1
(43) Pub. Date: Dec. 31, 2009

(54) Method for delivering liquid active agents for deodorising and disinfecting an enclosed space, in particular an animal enclosure

(76) Inventor: Karl Buchrucker sen, Ottensheim (AT)

Correspondence Address: COLLARD & ROE, P.C., 1077 NORTHERN BOULEVARD, ROSLYN, NY, 11576, US

(21) Appl. No.: 12/215,138

(22) Filed: Jun. 25, 2008

(51) Int. Cl. A01N 25/02; B01F 3/04

(52) U.S. Cl. 424/43; 261/78.2

(57) ABSTRACT

A method is described for delivering liquid active agents for deodorising and disinfecting an enclosed space (1), in particular an animal enclosure, wherein the active agents are sprayed with the aid of a compressed gas by means of atomizing nozzles (2) distributed in the enclosed space (1). In order to provide advantageous delivery conditions it is proposed that the active agents in the atomising nozzles (2) are selectively atomised either by means of fine atomisation using a high gas pressure to create an aerosol or by means of coarse atomisation using a low gas pressure to create a sinking fluid mist.

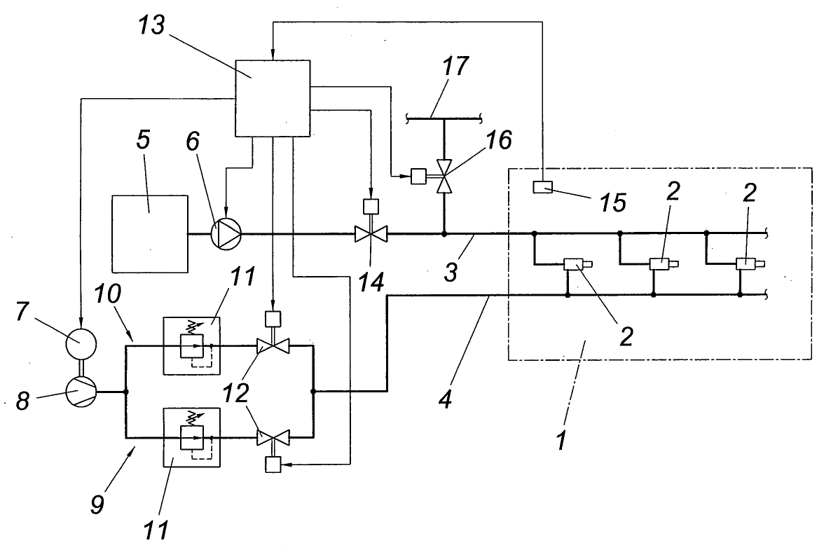

### FIELD OF THE INVENTION

The invention relates to a method for delivering liquid active agents for deodorising and disinfecting an enclosed space, in particular an animal enclosure, wherein the active agents are sprayed by means of atomizing nozzles distributed in the enclosed space with the aid of a compressed gas.

### DESCRIPTION OF THE PRIOR ART

Active agents are known that are suitable not only for deodorising but also for disinfecting purposes and that contain for example a combination of polyvalent alcohols, solubilizing agents and ethereal oils. These liquid active agents can be limitlessly diluted with water and can be delivered not only by means of spraying but also by vaporisation. For spraying, which has been shown to be particularly effective in practical applications, the liquid active agent, diluted accordingly, is sprayed finely in atomizing nozzles with the aid of a pressurised gas, normally air, with the aim of creating aerosols in order to maintain the active agent for as long as possible in the airspace in order to facilitate particularly effective use, in particular in enclosed spaces that involve the risk of environmental pollution in the form of odours, such as is the case for instance in the area of intensive animal husbandry.

In this context, a method is known (WO 2006/039918 A2) for creating stable aerosols which involves the transportation of the liquid active agent under pressure to an atomizing nozzle, which sprays the active agent in a jet of air injected through the nozzle. This air/active agent mixture is diluted in at least one downstream mixing chamber pressurised with compressed air, where the admission pressure of the mixing chamber can be set with the aid of a pressure regulator in such a way that there is a uniform, very fine distribution of the atomised active agent in the airflow discharged from the mixing chamber. However, it has been shown that despite the creation of very stable aerosols from the active agents employed, the disinfecting effect of these aerosols failed to fulfil expectations, above all in cases of increased contamination by infectious germs and the impending risk of infection.

### SUMMARY OF THE INVENTION

Consequently, the object of the invention is to design a method for delivering liquid active agents for deodorising and disinfecting enclosed spaces, in particular animal enclosures of the type described at the beginning, in such a way that not only the deodorising but also the disinfecting qualities of the active agents can be utilised advantageously.

The invention fulfils the objective by spraying the active agents in the atomising nozzles, either in the form of an aerosol by means of fine atomisation using a high gas pressure or in the form of a sinking fluid mist by means of coarse atomisation using a low gas pressure.

The invention is based on the knowledge that in the event of the increased risk of infection and/or an increased contamination from infectious germs effective disinfection can only be achieved if it can be guaranteed that the floor surfaces and the objects located in the enclosed space will be moistened with the active agent. As the delivery of the active agent into the enclosed space requiring disinfecting in the form of an aerosol alone is not sufficient to achieve this, in accordance with the invention the active agent is atomised using low gas pressure to form a fluid mist with liquid droplets that are large enough to fall to the ground under the force of gravity so that moistening of the surfaces in the area of the fluid mist can be guaranteed by means of the falling fluid mist. In order to achieve a deodorising effect, the aim is to distribute the active agent in the space as an aerosol, requiring the active agent to be atomised finely under high gas pressure. In order to be able to guarantee advantageous conditions, not only with respect to deodorisation, but also to disinfection, a particularly favourable situation can be achieved in this context when the fine atomisation and the coarse atomisation of the active agents can be performed alternately over time. An additional advantageous effect has proven to be the fact that moistening any fine particles in the enclosed airspace with the aerosols results in the precipitation of fine particles such that the active agents cause bonding that prevents any new swirling of deposited fine particulate.

The performance of such a method for delivering liquid active agents for deodorising and disinfecting an enclosed space can be based on atomising nozzles distributed in this enclosed space that are connected on the one hand to a compressed gas line and on the other to an active agent line. In order to atomise the active agents either finely or coarsely in the atomising nozzles, one only needs to apply a higher or lower gas pressure to the compressed gas line. In order not lo have to provide different sources of compressed gas, the compressed gas line can be connected to a common compressed gas source by means of one of either of two pressure regulators arranged in parallel, on the one hand for high gas pressure and on the other for low gas pressure, so that the cost of construction is relatively low.

If the active agent line can be combined selectively with either an active agent container or a water pipe, the device for delivering liquid active agents can be additionally employed to control the climate of the enclosed space as a fine atomised water mist can not only be used to increase the humidity of the enclosed space, but also to cool the enclosed airspace when the evaporation heat required for vaporising the water mist is removed from the enclosed airspace. As the size of the vaporised water droplets can be influenced by means of the pressure applied by the gas pressure line, it is also possible to ensure moistening of the floor of the enclosed space, for instance to facilitate cleaning of the enclosed space.

### BRIEF DESCRIPTION OF THE DRAWING

The method will be described in greater detail with reference to the drawing, namely a simplified functional block diagram showing a device in accordance with the invention for delivering liquid active agents for deodorising and disinfecting an enclosed space.

### DESCRIPTION OF THE PREFERRED EMBODIMENT

In order to deliver liquid active agents for deodorising and disinfecting an enclosed space 1 indicated by the dash-dotted line, e.g. for example an animal enclosure, provision is made for atomizing nozzles 2 in the enclosed space 1 that are connected to an active agent pipe 3 on the one hand and to a compressed gas line 4 on the other. The liquid active agents are transported to the atomizing nozzles 2 via the active agent pipe 3 from a reservoir 5 by means of a pump 6. The atomizing nozzles 2 are supplied with a compressed gas, preferably with compressed air, via a compressor 8 driven by a motor 7, with the pressure line from said compressor splitting into two branches 9 and 10 that feed into the compressed gas line 4, with each of said branches having a pressure regulator 11 and an on-off valve 12. While the branch 9 has a pressure regulator 11 for reducing the gas pressure to a low pressure level of for instance 0.5 to 1.5 bar, the pressure regulator 11 in the branch 10 can be set for a higher pressure level, for instance between 2 and 5 bar. The setting of the gas pressure by means of the pressure regulator 11 is selected in combination with the atomizing nozzles 2 such that the active agent transported by the active agent pipe 3 is atomised as a fine spray when the higher pressure is applied from the compressed gas line 4, while when a lower pressure is applied from the compressed gas line 4 an active agent mist with coarser water droplets is produced, with at least the greater part of it sinking due to gravitational force. The differing delivery of the active agents into the enclosed space 1 fulfils not only the deodorising, but also the disinfection and particulate binding requirements advantageously, in particular when the active agents are subjected to fine or coarse atomisation alternately at periodic intervals.

As can be seen from the functional block diagram, the delivery of the active agents into the enclosed space 1 can be automated with the aid of a control device 13 which triggers the actuator of an on-off valve 14 in the active agent line 3 together with the actuator of the two on-off valves 12 in the branches 9 and 10 of the pressure line of the compressor 8 in order to deliver the active agents into the enclosed space 1 at temporal intervals of for instance 15 minutes, alternating between fine atomisation, e.g. for 10 seconds and coarse atomisation, e.g. for 15 seconds. As the active agents are delivered at temporal intervals, the motor 7 for the compressor 8 and the pump 6 for the active agents are only switched on by means of the control device 13 for the duration of active agent atomisation. The atmospheric temperature and humidity in the enclosed space 1 must be taken into consideration in order for the desired effect of the atomised active agents to occur to the anticipated extent. Therefore, these parameters are measured by means of a sensor 15 and communicated to the control device 13 so that the delivery of active agents into the room 1 can be suspended if the room temperature fails to reach the specified limit values and/or the corresponding atmospheric humidity exceeds the limit values.

As a water pipe 17 can be attached to the active agent line 3 via an on-off valve 16 governed by the control device 13, it is possible with the aid of the device shown not only to distribute active agents but also water in various forms of atomisation in the enclosed space 1, a fact that opens another opportunity for influencing the atmosphere of the enclosed space because the humidity can be raised and the temperature can be reduced with the aid of the finely atomised water. Moistening of floor surfaces can be ensured when coarse atomisation is performed, a fact that can facilitate the cleaning of these floor surfaces.

1. Method for delivering liquid active agents for deodorising and disinfecting an enclosed space, in particular an animal enclosure, with the active agents being sprayed with the aid of a compressed gas through atomizing nozzles distributed around the enclosed space, wherein the active agents in the atomising nozzles are selectively atomised either in the form of an aerosol by means of fine atomisation using a high gas pressure or in the form of a sinking fluid mist by means of coarse atomisation using a low gas pressure.

2. Method in accordance with claim 1, wherein the active agents are alternately subject to fine and coarse atomisation at periodic intervals.

3. Device for performing a method for delivering liquid active agents for deodorising and disinfecting an enclosed space, in particular an animal enclosure in accordance with claim 1 using atomizing nozzles distributed around the enclosed space, connected to a compressed gas line on the one hand and to an active agent line on the other, wherein the compressed gas line can be subjected to higher or lower gas pressure to selectively atomise the active agent finely or coarsely.

4. Device in accordance with claim 2, wherein the compressed gas line can be connected selectively to a common compressed gas source by means of one of either of two pressure regulators arranged in parallel, for high gas pressure on the one hand and for low gas pressure on the other.

5. Device in accordance with claim 2, wherein the active agent line can selectively be connected with an active agent reservoir or a water pipe.
